(19) United States
(12) Patent Application Publication
(10) Pub. No.: US 2004/0102976 A1
(43) Pub. Date: May 27, 2004

(54) System for installation of a resource device on a computing device

(76) Inventor: Julie Pochueva, Camas, WA (US)

Correspondence Address: HIWLETT-PACKARD COMPANY, Intellectual Property Administration, P.O. Box 272400, Fort Collins, CO, 80527-2400, US

(21) Appl. No.: 10/307,060

(22) Filed: Nov. 27, 2002

(51) Int. Cl. G10L 21/00

(52) U.S. Cl. 704/270.1

(57) ABSTRACT

A system for use in installing a resource device on a computing device. The system typically includes an installer program having a graphical user interface (GUI) including a plurality of installation interfaces, each installation interface offering a different level of assistance to the user during an installation procedure. The GUI further may include a gateway GUI element configured to enable a user to select among the plurality of installation interfaces.

### BACKGROUND

In order to use a resource device, such as a printer, scanner, or facsimile machine, with a computing device, the resource device must first be “installed” on the computing device. The installation process typically involves connecting the resource device and the computing device via a cable or wireless link, setting up the resource device by installing a toner cartridge, etc., and loading software such as a device driver on the resource device to enable the computing device to communicate with the resource device. Unfortunately, many problems may occur during the installation process, frustrating both novice and experienced users alike.

One type of problem often encountered by users is that they do not know how to set up the resource device and component hardware such as cables, toner cartridges, trays, etc. At the time of installation, users have often just purchased the product, and are unfamiliar with the appearance of the resource device and its components. Thus, it is easy for users to make mistakes in assembling the resource device, or connecting the resource device to the computing device.

### SUMMARY

A system for use in installing a resource device on a computing device are provided. The system typically includes an installer program having a graphical user interface (GUI) including a plurality of installation interfaces, each installation interface offering a different level of assistance to the user during an installation procedure. The GUI further may include a gateway GUI element configured to enable a user to select among the plurality of installation interfaces.

### BRIEF DESCRIPTION OF THE DRAWINGS

FIG. 1 is a schematic view of an installation system according to one embodiment of the present invention.

FIG. 2 is a schematic view of a software architecture of an installer program of the installation system FIG. 1.

FIG. 3 is a schematic view of a graphical user interface of the installation system of FIG. 1.

FIG. 4 is a schematic view of the software architecture of the graphical user interface of FIG. 3.

FIG. 5 is a schematic view of user-specified settings and computing-device settings of the installation system of FIG. 1.

FIG. 6 is a pictorial view of exemplary graphical user interface screens of the installation system of FIG. 1.

FIG. 7 is a pictorial view of exemplary graphical user interface screens of the installation system of FIG. 1, continuing from FIG. 6.

FIG. 8 is a pictorial view of exemplary graphical user interface screens of the installation system of FIG. 1, continuing from FIG. 7.

FIG. 9 is a pictorial view of exemplary graphical user interface screens of the installation system of FIG. 1, continuing from FIG. 8.

FIG. 10 is a pictorial view of exemplary graphical user interface screens of the installation system of FIG. 1, continuing from FIG. 9.

FIG. 11 is a pictorial view of exemplary graphical user interface screens of the installation system of FIG. 1, continuing from FIG. 10.

FIG. 12 is a flowchart of a method according to one embodiment of the present invention.

### DETAILED DESCRIPTION

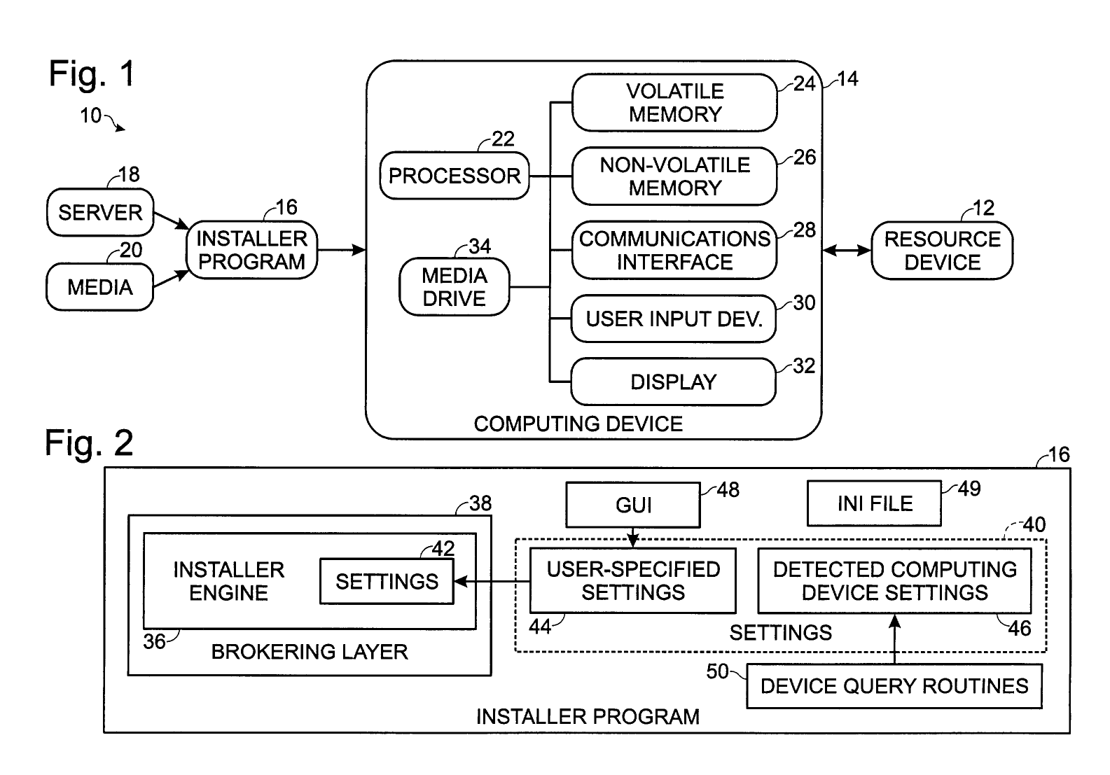

FIG. 1 shows, generally at 10, a system for installing a resource device 12 on a computing device 14 utilizing an installer program 16 obtained from an on-line server 18, media 20 (such as a CD ROM), or other source. As used herein, the term “resource device” refers to an external device used by a computing device to accomplish an input/output function. Examples of suitable resource devices include a printing device, a copier, a facsimile device, a scanner, an “all-in-one” device incorporating features of each of these devices, etc.

Computing device 14 typically includes a processor 22 linked via a communications bus to volatile and nonvolatile memory 24, 26, communications interface 28, user input device 30 (typically a keyboard, mouse, etc.), display 32, and media drive 34. Computing device 14 is typically configured to download installer program 16 via communications interface 28 from server 18, and/or to read installer program 16 from media 20 via media drive 34. Processor 22 generally is configured to execute the installer program using portions of memory 24, 26. It will be understood that the term “program” as used herein may refer to one or more files, including executable files, function libraries, data files, etc., which interact together as a group, and does not necessarily refer to a single program file.

As shown in FIG. 2, installer program 16 typically includes an installer engine 36, and a brokering layer 38 through which information such as settings 40 are passed. The brokering layer may transform settings 40 into engine readable form, shown at 42. Settings 40 typically include user-specified settings 44, obtained via graphical user interface (GUI) 48, and detected computing device settings 46, obtained via device query routines 50. Settings 40 may also include a resource device type or other resource device setting obtained by the computing device from the resource device during the installation process.

As shown in FIG. 5, user-specified settings 44 may include a setting for the connection type between the resource device and computing device (e.g. USB or parallel), a setting for the presence or absence of a resource device accessory (such as a duplexer), or a wide variety of other user-selectable parameters. Computing device settings 46 typically include hardware and software settings for computing device 14, such as operating system (OS) type, language, and system state (e.g. supported connection types to resource device 12, etc.).

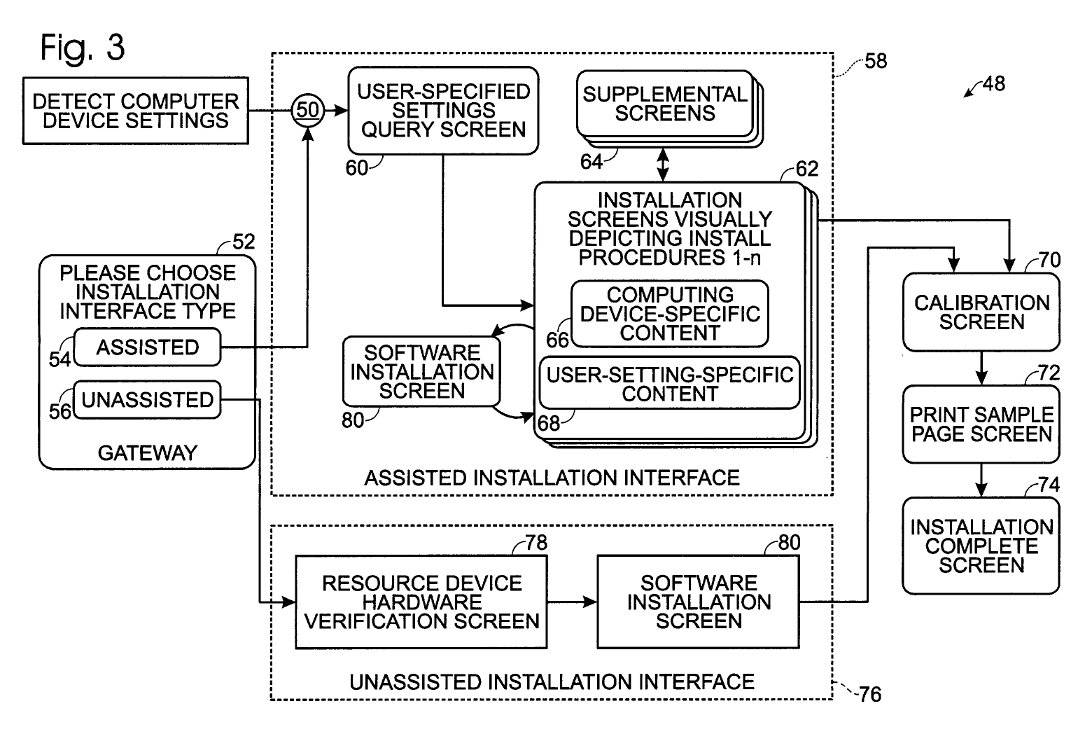

FIG. 3 shows a schematic view of an exemplary GUI 48. The GUI typically includes a gateway GUI element 52 including an assisted installation interface selector 54 and an unassisted installation interface selector 56. Typically, selectors 54, 56 are buttons or other user-selectable interface elements included within a screen or menu of GUI 48.

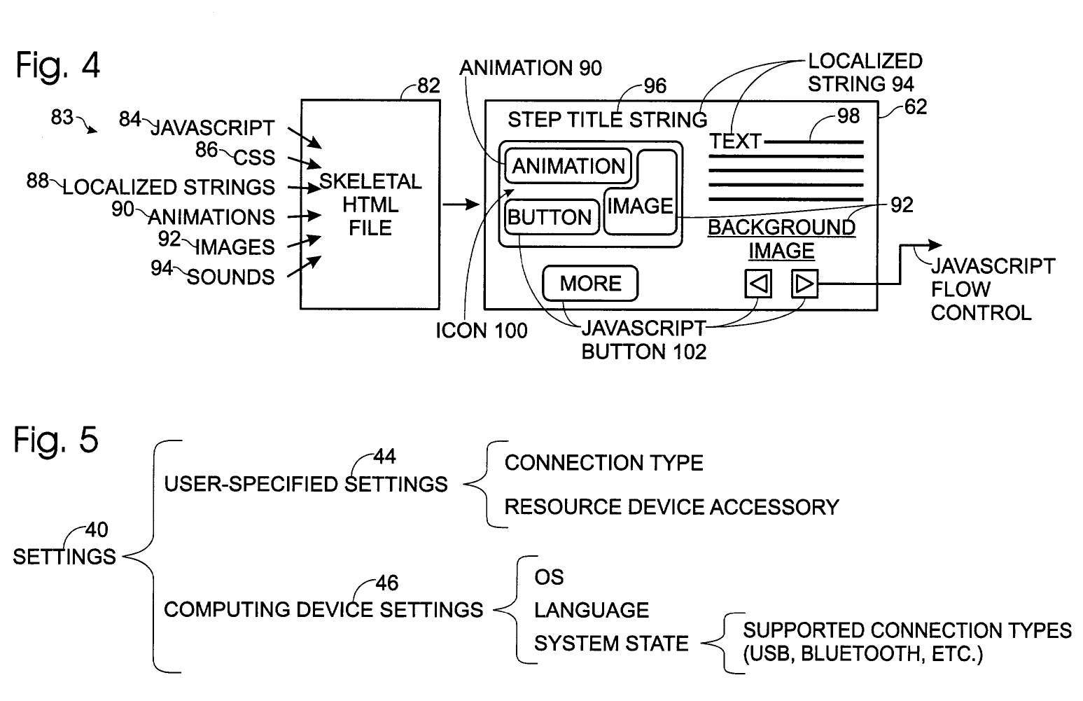

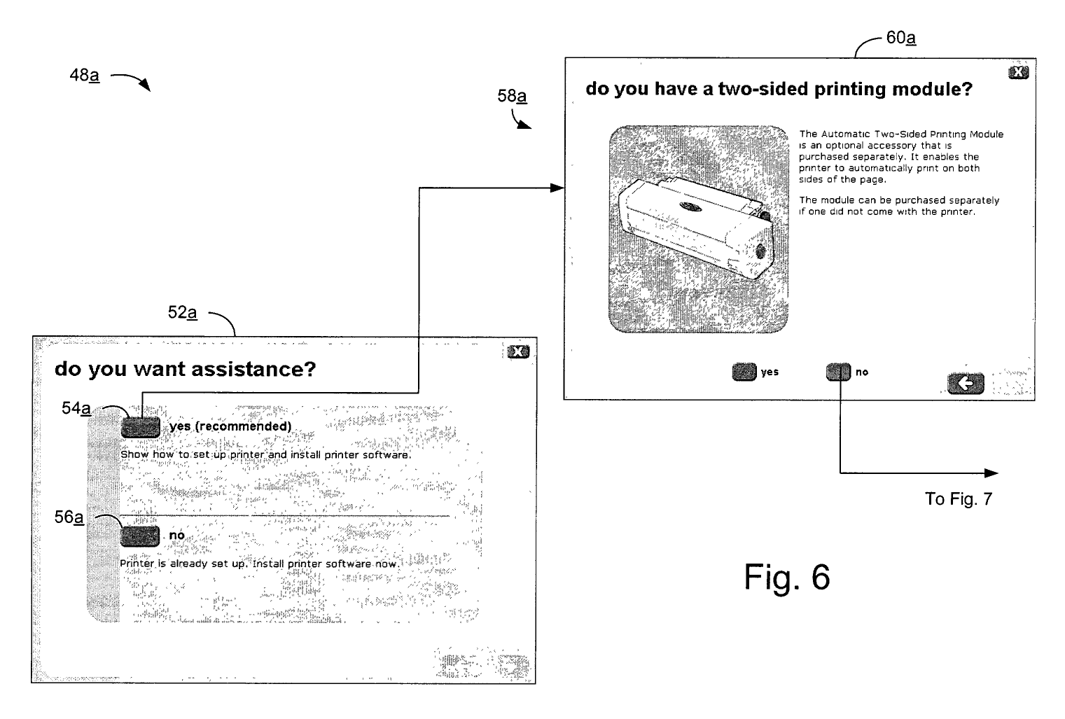

Upon actuation of assisted installation interface selector 54, GUI 48 is configured to present an assisted installation interface 58, having a user-specified settings query screen 60, a plurality of installation screens 62 visually depicting a series of installation procedures, and one or more supplemental screens 64 accessible from the installation screens 62. A software installation screen 80 is also typically provided, which is accessed from one of the installation screens 62. Installation screens 62 also typically include an icon, shown at 100 in FIG. 4, visually depicting an installation procedure. The icon may include a still image, an animation, or both. Each of the icons discussed herein typically includes an accurate and lifelike visual representation of the resource device 12 and its associated components, such that the user may easily recognizes these parts. Screenshots from an exemplary GUI 48a having an assisted installation interface 58a according to one embodiment of the present invention, are shown in FIGS. 6-11.

Assisted installation interface 58 typically is configured to trigger device query routines 50, which detect computing device settings 46. Typically, computing device settings 46 are detected without displaying any window, screen, or other GUI element. Computing device settings 46 are typically detected prior to the display of installation screens 62, either before, contemporaneously with, or after the display of user specified-settings query screen 60. As described above, the computing device settings 46 may be, for example, hardware and software settings for computing device 14, such as operating system (OS) type, language, and system state (e.g. supported connection types to resource device 12, etc.). One example of an gateway GUI screen is shown at 52a in FIG. 6, having selectors 54a and 56a for choosing an assisted or unassisted installation interface.

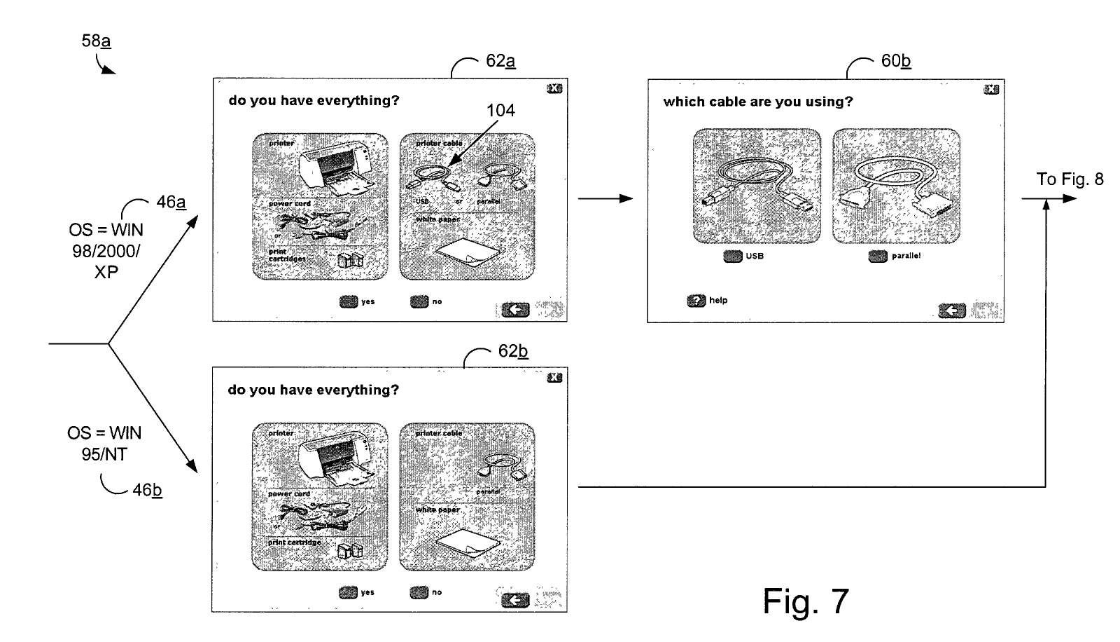

User-specified settings query screen 60 typically is configured to enable a user to enter one or more of user-specified settings 44, such as a setting indicating the presence or absence of a duplexer or other resource device accessory, as described above. Exemplary user-specified settings query screens are shown at 60a, 60b in FIGS. 6 and 7.

Assisted installation interface 58 is also typically configured to present installation screens 62 that include computing device-specific content 66 and/or user-setting-specific content 68, based on user-specified settings 44 and detected computing device settings 46, respectively. Exemplary installation screens are shown at 62a-62i, in FIGS. 7-10.

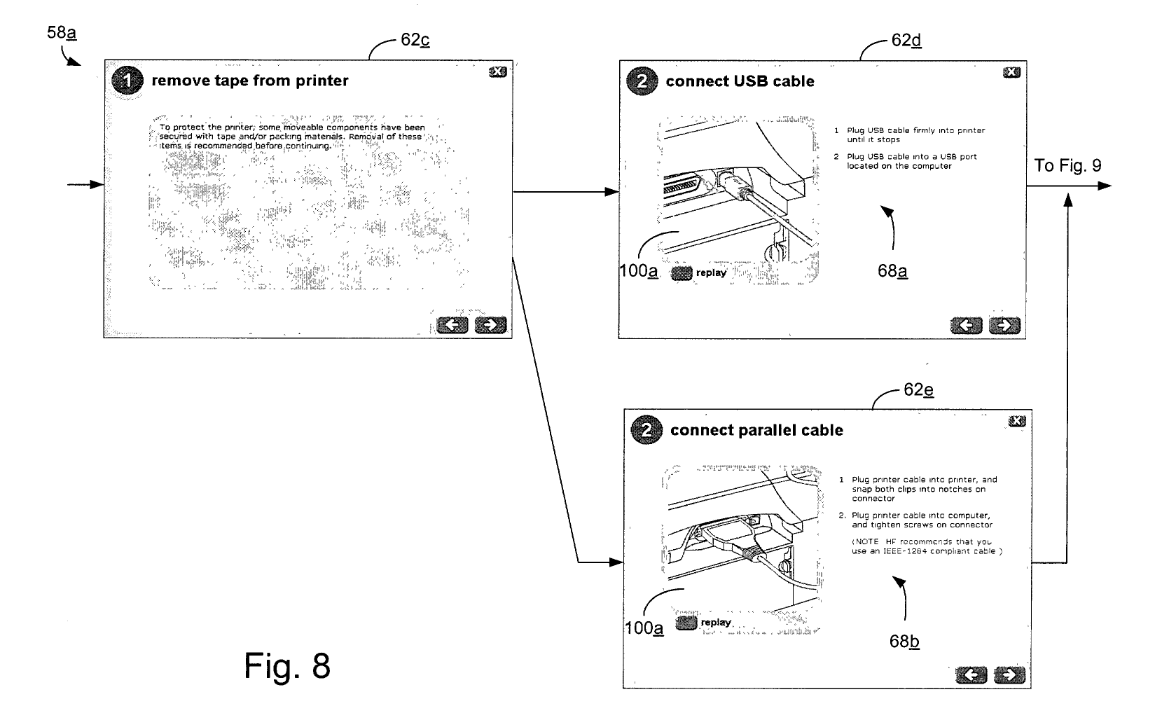

One example of user-specified settings 44 and related user-setting-specific content 68 is illustrated by the USB/Parallel cables shown in FIGS. 7 and 8. In FIG. 7, a user-specified settings query screen 60b is presented, in which the user is asked whether the user would like to connect the resource device with a USB or parallel cable. In response, the user selects a “USB” selector or a “Parallel” selector on screen 60b. This selection results in a user-specific setting 44, which in turn causes assisted installation interface 58a to display either the user-setting specific content 68a (animation and text for USB cable) or 68b (animation and text for Parallel cable) shown in screens 62d or 62e of FIG. 8, as appropriate.

One example of computing device settings 46 and computing device-specific content 66 is illustrated in FIG. 7. Device query routines 50 detect an operating system setting, two of which are shown at 46a, 46b. In response, for USB enabled operating systems, assisted installation interface 58a is configured to display an installation inventory screen 62a including a icon 104 depicting a USB cable. For operating systems that are not USB enabled, assisted installation interface 58a is configured to display installation inventory screen 62b, without any such USB cable icon.

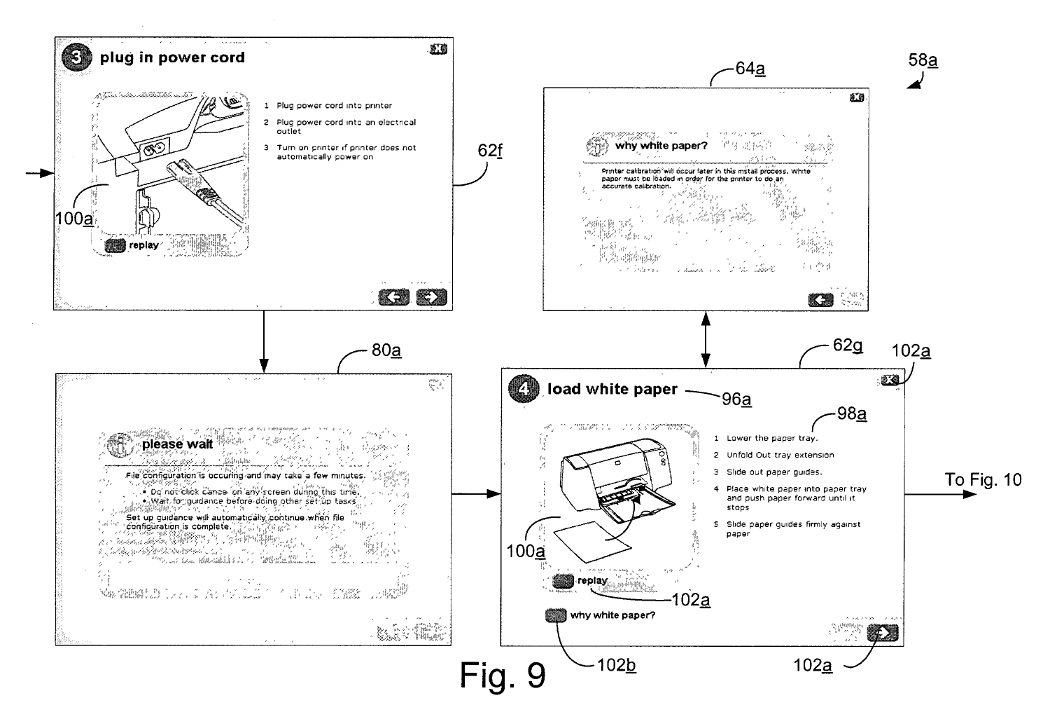

One example of a supplemental screen 64 is shown at 64a in FIG. 9. Supplemental screen 64a includes an explanation of the reasons for using white paper during the installation process, and is typically accessed by user-actuation of selector 102b. Other supplemental screens may include error messages, help information, calibration interfaces, etc.

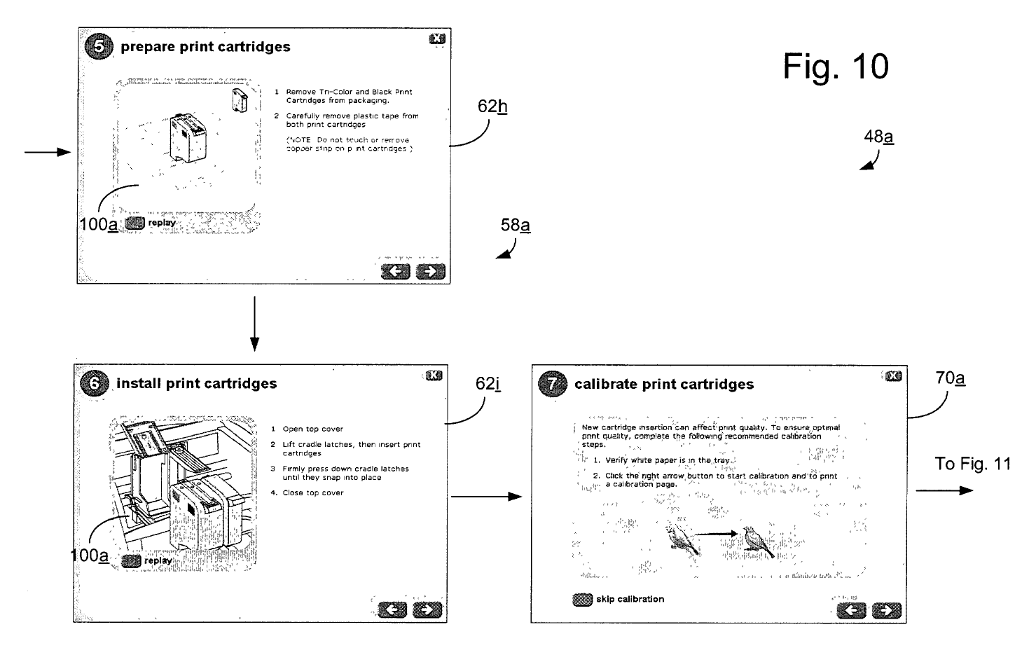

During the installation process, the user typically passes through the installation screens 62 of assisted installation interface 58 to arrive at a calibration 70 of GUI 48, which is configured to enable a user to adjust the color output of print cartridges of the resource device 12. An example calibration screen is shown at 70a in FIG. 10.

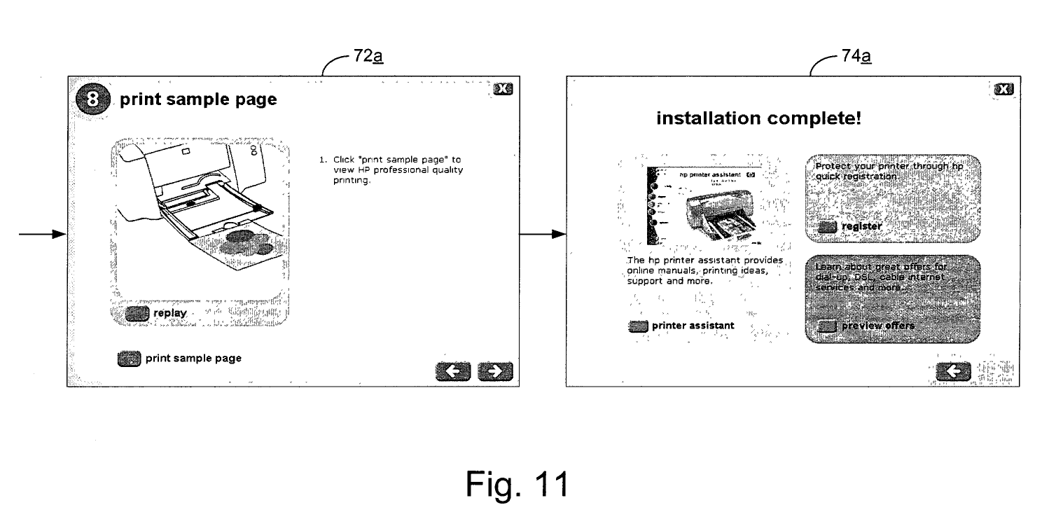

GUI 48 further includes a print sample page screen 72, an example of which is shown at 72a in FIG. 11, by which a user may print a sample page and verify that the newly installed resource device 12 can correctly print documents sent from computing device 14, using the levels calibrated via calibration screen 70. GUI 48 further includes an installation complete screen 74, an example of which is shown at 74a in FIG. 11, which indicates to the user that the installation of the resource device was successfully completed.

Referring back to FIG. 3, it will be noted that to access unassisted installation interface 76, the user chooses a selector 56 on gateway GUI element 52. Typically, a resource device hardware verification screen 78 is shown, featuring a textual listing of the parts that the user should have assembled in order to conduct the installation. Upon pressing “OK” or the like, the user is passed to a software installation screen 80, which typically is similar in appearance to screen 80a in FIG. 9, having a bar graph that charts the progress of the software installation process. During this process, various software files that facilitate communication between resource device 12 and computing device 14, such as device drivers, data files, etc., are installed on computing device 14 by the installer program 16.

FIG. 4 shows an exemplary software architecture used to produce the various installation screens 62 of the above-described embodiments. Typically, a skeletal GUI file 82 is created, which is typically a markup language file written in a hypertext markup language (HTML). Skeletal GUI file 82 typically includes internal data, such as data for a title or other static text, as well as links to support GUI files 83 used to provide a variety of static and dynamic GUI elements within GUI 48. The skeletal GUI file and the support files may be read by a browser (typically executed within the installer program itself), which in turn displays GUI 48 on computing device 14. It will be understood that a “browser,” as the term is used herein, is not limited to dedicated programs such as Microsoft® Internet Explorer, but also includes embedded browser modules contained within application programs that may be configured to display HTML files.

The term “static GUI element” refers to GUI elements that are stored as data files on computing device 14, while “dynamic GUI element” refers to GUI elements that are created “at run time,” e.g., at the time the function calls from the skeletal GUI file cause an associated executable script file (such as a JavaScript file or other executable program) to run. The output of the executable script file may be used to determine, dynamically, the content and functionality of a GUI element on GUI 48. Specifically, the script program may determine, at run time, a particular graphic, text, sound, animation, or image to display, and an associated script or hyperlink, if any, that should be activated when a user clicks on the graphic, text, sound, animation, or image. For example, JavaScript files may be used to create buttons at run time that lead to various different screens, depending on the device and user settings.

Support GUI files 83 may further include executable script files such as JavaScript files 84 configured to control the presentation of a dynamic GUI element of the graphical user interface, such as buttons, sounds, images, animations, text etc. The support GUI files may further include format files such as cascading style sheet (CSS) files 86, which may include instructions for formatting the various GUI elements of screens 62. Support GUI files 83 may also include localized string files 88, which are typically implemented in XML, or other extended markup language. Support GUI files 83 also may include animation files 90, image files 92, and sound files 94, which are used to display corresponding static GUI elements. The browser may be configured to read the skeletal GUI file and the various support GUI files, and render the appearance and functionality found in installation screens 62.

The displayed installation screens 62 typically include a title 96, as well as a textual description 98 produced using localized strings 88. Installation screens 62 further typically include an icon including one or more animations 90 and/or images 92, which visually depict an installation process described in textual description 98. A background image may also be provided. Various buttons 102 may be implemented using JavaScript files 84, as described above. Run time logic in the JavaScript files typically controls the flow from one installation screen 62 to another, as described above. Reference may be made to screen 62g in FIG. 9, which illustrates many of these features, which are correspondingly numbered 96a-102a (and 102b).

The software architecture described above enables a developer to easily create a new version of the installer program for a different resource device, by changing only certain portions of the installer program. Typically, the installer program may be created with all resource-device-specific data stored both in a predetermined subset of the support GUI files, and also in an initialization file, shown at 49 in FIG. 1. As used herein, the term “resource-device-specific data” refers to data that is specific to one particular resource device, or to a class of resource devices, but that is not shared by all resource devices with which the installer program may be used. For example, a desktop printing device and a floor standing printing device may have different appearances, and thus may utilize different resource-device-specific image files and animation files illustrating each printer. The term “initialization file” is used to refer to a file that contains settings and parameters used to execute a new instance of the installer program for the resource device. Typically, the initialization file includes both resource-device-specific data containing operational settings and parameters relating to functionality of a specific resource device or specific class of resource devices, as well as resource-device-independent data that contains operational settings and parameters for all resource devices.

The developer may adapt the installer program for use with a different resource device by changing the resource-device-specific data in the initialization file, and replacing the support GUI files containing data for resource-device-specific GUI elements, which may classify as either static or dynamic GUI elements. Resource-device-specific GUI elements such as text, buttons, animations, images, and sounds are typically replaced. This is usually accomplished by altering or replacing corresponding support GUI files such as localized text files, executable script files, image files, animation files, and/or sound files associated with the installer program. For example, an animation file illustrating replacement of a toner cartridge on a first printing device may be replaced with an animation illustrating replacement of a toner cartridge on a second printing device. Replacing only these files may save significant time over prior development methods, which require that the entire installer program be rewritten.

Turning now more particularly to FIGS. 6-11, a path through a GUI 48a according to one exemplary embodiment of the invention will be described. First, a user chooses assisted installation interface option 54a of gateway GUI element 52a, which causes a user-specified settings query screen 60a to be displayed, with the title “Do you have a two-sided printing module?” As discussed above, user selection of “no” or “yes” will cause a user-specified setting 44 to be assigned indicating the presence or absence of a two-sided printing module, or duplexer.

In FIG. 7, device query routines 50 typically query computing device 14 for computing device settings 46, such as OS types 46a, 46b, as described above. GUI 48a is configured to present an inventory check installation screen 62a or 62b with computing device-specific content 66, such as the presence of USB cable 104 in screen 62a, or its absence in screen 62b, based on whether the detected OS-type supports USB connections. Of course, icons for other connection methods, such as Bluetooth, may also be provided.

If more than one connection type is supported, the user is typically presented with a second user-specific settings query screen 60b, in which the user is asked to select a desired connection type, such as a USB or parallel cable. Once again, a Bluetooth option may also be provided in screen 60b. At 62c in FIG. 8, an installation screen is presented, instructing the user to remove tape securing movable components from the printer. At 62d or 62e, the user is presented with an installation screen that includes an animation of how to plug the selected cable into an appropriate USB or parallel communications port of the resource device. The cable displayed at 62d , 62e is either selected by the user at 60b, or is selected by GUI 48a when computing device-specific settings 46 indicate that only one connection type is supported. Thus, the content of screens 62d , 62e may be based on user-specified settings 44 in some instances and computing device-specific settings 46 in other instances.

As shown in FIG. 9, assisted installation interface 58a also typically presents an interface screen 62f including an icon 100a featuring an animated depiction (and textual description) of plugging in the power cord into a power cord port of the resource device. Assisted installation interface 58a further typically includes a software installation screen 80a having a progress bar that measures the progress of the installation of software files on computer 12. Typically these software files include print drivers and other programs and data useful in interacting with resource device 12.

Assisted installation interface 58a also includes an interface screen 62g having an animation 100a (and textual description) illustrating the process for loading white paper into a paper tray of resource device 12. Selection of button 102b causes a supplemental screen 64a to appear with an explanation of the reason for using white paper in the installation process.

As shown in FIG. 10, assisted installation interface 58a also includes an interface screen 62h having an animation 100a (and textual description) illustrating the process for preparing print cartridges to be loaded into resource device 12. Installation screen 62i includes an animation (and textual description) illustrating how to install print cartridges into a print cartridge holder of resource device 12.

After completing each of the steps illustrated in installation screens 62a-62i, the user is passed to calibration screen 70a, for calibration of the print cartridges in the resource device. Several supplemental screens are typically involved in the calibration process, via which the user may enter and adjust various calibration parameters.

As shown in FIG. 11, GUI 48a further includes a print sample page screen 72a by which the user may print a sample page on the resource device according to the parameters and settings adjusted during the installation process. Upon verification that the page was correctly printed, the user is passed to a installation complete screen 74a, indicating to the user that the installation process has been successfully completed. Screen 74a also typically includes hyper links to register the product online, preview offers of related accessories, and view a printer assistant tutorial on the resource device.

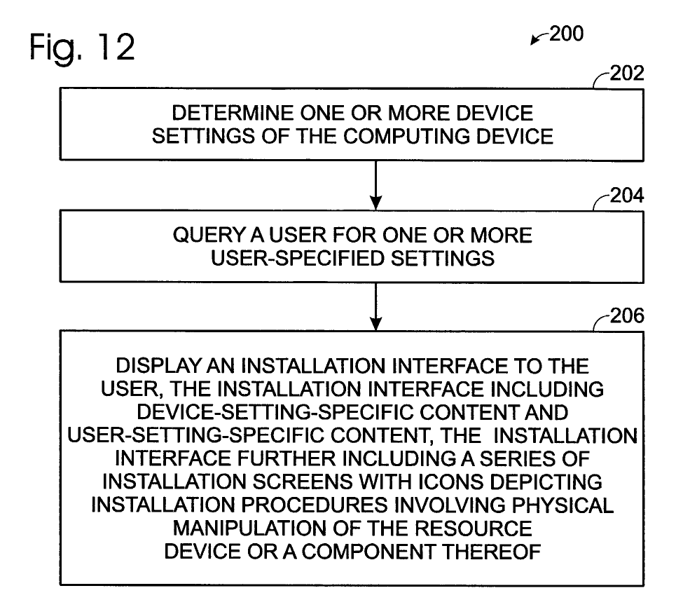

FIG. 12 shows, generally at 200, a method for use in installation of a resource device on a computing device according to one embodiment of the present invention. Method 200 typically includes, at 202, determining one or more device settings 46 of the computing device. This is typically accomplished by device query routines 50, as described above.

At 204, the method typically includes querying a user for one or more user-specified settings 44. This is typically accomplished via user-specified settings query screen 62 of assisted installation interface 58, as described above.

At 206, the method typically includes displaying an installation interface 58 to the user. The installation interface 58 typically includes computing device-specific content 66 and user-setting-specific content 68. The installation interface 58 typically includes a series of installation screens 62 with icons 100 depicting installation procedures involving physical manipulation of the resource device or a component thereof, such as a communication cable, power cord, print cartridge, etc.

Typically, the method also includes generating the user-setting-specific content based on the user-specified settings, and/or generating the computing device-specific content based on the device settings. This may be accomplished at run time, that is, as the user is making the selections or as the device settings are queried. Typically this run time logic is achieved by use of JavaScript files called by a skeletal GUI file, as described above.

As described above, determining one or more device settings may include determining a hardware or software setting of the computing device. The hardware setting may be a port configuration, screen setting, etc. of the computing device. The software setting may be selected from the group consisting of operating system type, language, and supported connection types, among others. In response to querying the user, the method further may include receiving a user-specified setting for the connection type between the resource device and computing device, and/or receiving a user-specified setting for the presence or absence of a resource device accessory.

The method may further include displaying an animated icon depicting one or more of the following installation procedures: installation of a communication cable (such as a USB or parallel cable) on the resource device, installation of a power cord on the resource device, loading paper into the resource device preparation of print cartridges for the resource device, and/or installation of print cartridges into the resource device.

The embodiments of the present invention have industrial applicability to the computing device and resource device industries in that they may be used to install resource devices on computing devices.

While the present embodiments have been particularly shown and described, those skilled in the art will understand that many variations may be made therein without departing from the spirit and scope defined in the following claims. The description should be understood to include all novel and non-obvious combinations of elements described herein, and claims may be presented in this or a later application to any novel and non-obvious combination of these elements. Where the claims recite “a” or “a first” element or the equivalent thereof, such claims should be understood to include incorporation of one or more such elements, neither requiring nor excluding two or more such elements.

What is claimed is:

1. An installer program for use in installing a resource device on a computing device, the installer program being stored on a computer readable medium and executable by a computing device, the installer program comprising:
a markup language data file for a graphical user interface of the installer program, the graphical user interface including a screen illustrating an installation procedure for installing the resource device on the computing device; and
an executable script file configured to control presentation of a dynamic GUI element of the graphical user interface;
wherein the markup language data file includes a call to the executable script file, the markup language data file being configured to be read by a browser, which in turn is configured to trigger execution of the executable script program and presentation of the GUI element to the user via a display of the computing device.

2. The installer program of claim 1, wherein the dynamic GUI element is selected from a group consisting of text, buttons, animations, images, and sounds.

3. The installer program of claim 1, wherein the markup language data file further includes links to static GUI elements.

4. The installer program of claim 3, wherein the static GUI elements are selected from a group consisting of text, images, sounds, and animations.

5. The installer program of claim 1, further comprising, an initialization file containing resource-device-specific data used in initializing the installer program.

6. The installer program of claim 5, wherein the installer program may be configured to install a different resource device by altering the resource-device-specific data in the initialization file.

7. The installer program of claim 5, wherein the installer program may be configured to install a different resource device by replacing resource-device-specific files selected from the group consisting of script files, text files, image files, sound files, and animation files.

8. A method of developing installer programs for installing resource devices on computing devices, the method comprising:
creating an installer program configured to install a resource device on a computing device, the installer program having an initialization file containing resource-device-specific data, a skeletal GUI file configured to be read by a browser, and a plurality of support GUI files linked to the skeletal GUI file, the support GUI files including data for resource-device-specific GUI elements to be contained within a graphical user interface presented via the skeletal GUI file; and
adapting the installer program for use with a different resource device by changing the resource-device-specific data in the initialization file to data specific to the different resource device, and replacing the support GUI files including data for resource-device-specific GUI elements with support GUI files including data specific to the different resource device.

9. The method of claim 8, wherein the resource-device-specific GUI elements are selected from a group consisting of text, buttons, animations, images, and sounds.

10. The method of claim 8, wherein the skeletal GUI file is a markup language file.

11. The method of claim 8, wherein the support GUI files are selected from a group consisting of localized text files, executable script files, image files, animation files, and sound files.

12. A system for use in installing a resource device on a computing device, the system comprising:
an installer program having a graphical user interface (GUI) including a plurality of installation interfaces, each installation interface offering a different level of assistance to the user during an installation procedure, the GUI further including a gateway GUI element configured to enable a user to select among the plurality of installation interfaces.

13. The system of claim 12, wherein the plurality of installation interfaces includes an assisted installation interface having one or more icons illustrating an installation procedure.

14. The system of claim 13, wherein the icon includes an animation.

15. The system of claim 13, wherein the assisted installation interface is configured to determine computing device settings, and wherein the assisted installation interface includes a plurality of screens, and at least one of the screens includes computing device-specific content.

16. The system of claim 15, where the computing device-specific content is based on a detected language, operating system, or system state of the computing device.

17. The system of claim 13, wherein the assisted installation interface is configured to receive user-specified settings, and wherein the assisted interface includes a plurality of screens, and at least one of the screens includes user-setting-specific content.

18. The system of claim 17, wherein the user-specified settings include a user-selected resource device accessory.

19. The system of claim 13, wherein the plurality of installation interfaces includes an unassisted installation interface, having no visual depiction of an installation process.

20. The system of claim 12, wherein the resource device is a printing device, and wherein the installation interface is configured to install the printing device on the resource device.

21. A system for use in installing a resource device on a computing device, the system comprising:
an installer program having a graphical user interface including a series of interface screens describing installation procedures involved in installing the resource device on the computing device, at least one of the screens having an animated icon depicting a manual operation to be performed by the user on the resource device or a component thereof.

22. The system of claim 21, wherein the animated icon depicts installation of a cable on the resource device.

23. The system of claim 22, wherein the cable is selected from the group consisting of a USB cable and a parallel cable.

24. The system of claim 21, wherein the animated icon depicts the installation of a power cord on the resource device.

25. The system of claim 21, wherein the animated icon depicts loading paper into the resource device.

26. The system of claim 21, wherein the animated icon depicts preparing print cartridges for the resource device.

27. The system of claim 21, wherein the animated icon depicts installing print cartridges into the resource device.

28. A installer program for use in installation of a resource device on a computing device, the installer program comprising:
a graphical user interface including a user-specified settings query screen configured to receive user-specified settings;
device query routines configured to detect computing device settings;
one or more installation screens configured to display computing device-specific content based on the detected computing device settings; and
one or more installation screens configured to display user-setting-specific content based on the user-specified settings.

29. The program of claim 28, wherein the computing device-specific content includes an icon depicting an installation procedure involving the resource device or an accessory thereof.

30. The program of claim 29, wherein the icon is animated.

31. The program of claim 28, wherein the user-setting-specific content includes an icon depicting an installation procedure involving the resource device.

32. The program of claim 31, wherein the icon is animated.

33. The program of claim 28, wherein the computing device-specific settings include hardware settings for the computing device.

34. The program of claim 28, wherein the computing device-specific settings include software settings for the computing device.

35. The program of claim 34, wherein the software settings are selected from the group consisting of operating system type, language, and supported connection types.

36. The program of claim 28, wherein the user-specified settings include a setting for the connection type between the resource device and computing device.

37. The program of claim 28, wherein the user-specified settings include a setting for the presence or absence of a resource device accessory.

38. A method for use in installation of a resource device on a computing device, the method comprising:
determining one or more device settings of the computing device;
querying a user for one or more user-specified settings; and
displaying an installation interface to the user, the installation interface including computing device-specific content and user-setting-specific content, the installation interface having a series of installation screens with icons depicting installation procedures involving physical manipulation of the resource device or a resource device accessory.

39. The method of claim 38, further comprising, generating the user-setting-specific content based on the user-specified settings.

40. The method of claim 38, further comprising, generating the computing device-specific content based on the device settings.

41. The method of claim 38, wherein determining one or more device settings includes determining a hardware setting of the computing device.

42. The method of claim 38, wherein determining one or more device settings includes determining a software setting of the computing device.

43. The method of claim 32, wherein the software setting is selected from the group consisting of operating system type, language, and supported connection types.

44. The method of claim 38, further comprising, in response to querying the user, receiving a user-specified setting for the connection type between the resource device and computing device.

45. The method of claim 38, further comprising, in response to querying the user, receiving a user-specified setting for the presence or absence of a resource device accessory.

46. The system of claim 38, further comprising, displaying an animated icon depicting installation of a communication cable on the resource device.

47. The system of claim 38, further comprising, displaying an animated icon depicting the installation of a power cord on the resource device.

48. The system of claim 38, further comprising, displaying an animated icon depicting loading paper into the resource device.

49. The system of claim 38, further comprising, displaying an animated icon depicting preparation of print cartridges for the resource device.

50. The system of claim 38, further comprising, displaying an animated icon depicting installation of print cartridges into the resource device.
